(19) United States
(12) Patent Application Publication
(10) Pub. No.: US 2012/0099305 A1
(43) Pub. Date: Apr. 26, 2012

(54) RGB LED PACKAGE FOR OPTIMIZED EMISSIONS OF PHOTOSYNTHETICALLY ACTIVE RADIATION

(76) Inventor: Jeffery Bucove, Victoria (CA)

(21) Appl. No.: 13/133,937

(22) PCT Filed: Dec. 9, 2009
(86) PCT No.: PCT/CA2009/001793

§ 371 Date: Aug. 8, 2011

Related U.S. Application Data
(60) Provisional application No. 61/121,517, filed on Dec. 10, 2008.

(51) Int. Cl. F21V 9/00

(52) U.S. Cl. 362/231

(57) ABSTRACT

Disclosed is a device for providing photosynthetic photon flux to a plant by the simultaneous emission of red, green and blue light at photosynthetically active wavelengths. Light emitting diodes emitting red, green and butte at photosynthetically active wavelenghts are used.

### BACKGROUND ART

This invention is related to the field of using photosynthetically active radiation to optimize plant growth and more specifically to a RGB LED package for optimized emissions of photosynthetically active radiation.

It is well known that proper lighting is the key ingredient in promoting robust and healthy plant growth. It is also known that optimized spectral outputs can be achieved to meet, the specific needs of various plains during their growth phases. These spectral outputs are not necessarily visible to the human eye but rather fall into wavelengths in an area of electromagnetic spectrum deemed P.A.R. or Photosynthetic Active Radiation.

LEDs are becoming more popular in providing an optimized spectral output. However, discrete color LEDs produce radiance originating from geometrically distinct locations. RGB LEDs combine three or more colors of LED color which originate from a near geometrically common location, and are used in human lighting to produce the illusion of color though primary color mixing, or ‘chroma perception’ in the human visual cortex. This is why presently available RGBs do not provide the optimized spectral output or P.P.F. (Photosynthetic Photon Flux). The present invention seeks to provide a RGB LED that emits P.P.F. in the optimized P.A.R. wave lengths from a common point source at various wattages, eliminating ‘line of origin’ separate color shadows and thus color hot spots, for the purpose of enhancing horticultural, lighting applications.

### DISCLOSURE OF INVENTION

### Technical Problem

The shortcomings and deficiencies cited above are resolved by the provision of my invention which is a RGB (RED-GREEN-BLUE) LED having a spectral output in optimized wave lengths for plant growth.

Utility is enhanced by reducing hot spotting of specific colors found in common horticultural LED lights which use discrete color LEDs at various locations within the light fixture. This purpose is economically accomplished by using an already standardized and preexisting ‘RGB’ LED package (which are manufactured with the intended use as ‘primary color mixed color’ or ‘chroma color’ sources for human perceptual illusion of color). We alter the preexisting standard RGB LED package to produce three different colors, each color component altered to a specifically chosen spectral peak power to regulate and/or promote one or more aspects of plant growth, and all three colors delivering radiance from a geometrically common point of origin, thus eliminating the color hot spots and color specific shadows produced by the angular dispersal of colors radiating from the various geometries of the disparate and discretely located color sources found in common horticultural LED lighting.

The RGB LED can be made in 1 watt, 3 watt, 5 watt, and 10 watt outputs. Other RGB LEDs can be constructed with a variety of wattages. A 1 w RGB LED will comprise 3 light emitting diodes. A 3 w RGB LED will comprise 6 light emitting diodes and a 5 or 10 watt RGB LED will comprise a 9 light emitting diodes. The spectral emissions of the RGB LED are specific to plant growth and ensure that plants subjected to P.A.R. produced by the invention receive an even distribution of the appropriate spectral quality.

In different embodiments of the invention, the PPF-RGB-LED comprises the following chip sets to achieve appropriate P.P.F.:

1 watt LED: 1 blue emitter at 450 nm

1 green emitter at 525 nm

1 red emitter at 666 nm

3 watt LED: 1 blue emitter at 450 nm and 1, at 470 nm

2 green emitters at 525 nm

1 red emitter at 640 nm and 1 at 666 nm or (alternatively 1 red emitter at 666 nm and 1 at 680 nm)

5 watt LED: 1 blue emitter at 450 nm and 2 at 470 nm

1 or 3 green emitters at 525 nm

1 red emitter at 640 nm and 2 at 666 nm

(alternatively 2 red emitters at 666 nm and 1 at 680 nm)

The wavelengths of the emitters chosen when using existing RGB LED packages will always be three, but they need not be limited to the various wavelengths specified above, but can be any set or superset of desired wavelengths for which the emitters can he grouped into any of three electrically compatible subgroups for the purposes of becoming wired into the three electric path equipped RGB LED packaging. Thus Uva emitters electrically compatible with emitters at 450 nm could be grouped together on the ‘blue’ electric pathway, and iR emitters could be grouped with Far Red emitters, as well as various shades of green and/or gold being grouped together to provide these photomorphic waveforms to the three electric pathway equipped RGB packaging.

The PFF-RGB-LEDs are mounted into an RGB LED package and may have mixed power output bands to achieve optimum growth for the species of plant being irradiated. In another embodiment of the invention an infrared component may also be added to the LED package.

The emitter chips inside of the RGB LED package can be wired in series, or parallel. The emitter chips inside the RGB LED package can be wired in groupings defined by color and electronic characteristics. The RGB package may externally have 4 power contacts, or 6 power contacts. If an RGB package has a contact common to all three emitter groups, that contact may be either anode or cathode. If the emitter groups are internally wired in independent groups Without an anode or a cathode common to all groups, then the RGB package will have 6 power contacts.

In another embodiment of the invention the PPF-RGB-LEDs are mounted to a board for educational use to demonstrate plant reactions to various spectral outputs. A power algorithm may be used to balance power output of various PPF-RGB-LEDs over time across each of three colour sets of two emitters each. The colours are switched at a speed of 100 hz which is faster than the human eye can detect.

### Technical Solution

Advantageous Effects

### DESCRIPTION OF DRAWINGS

FIG. 1 is a photograph of one embodiment of the invention, namely, a 9 chip PPF-RGB-LED.

FIG. 2 is a diagram of (−) and (+) connections between the light emitting diodes and the pins.

FIG. 3 is a diagram of the PPF-RGB-LED of FIG. 1 showing (−) and (+) connections between the light emitting diodes and the pins.

FIG. 4 is a schematic diagram of one embodiment of the invention.

FIG. 5 is one embodiment of a power algorithm.

FIG. 6 is another embodiment of a power algorithm.

FIG. 7 is a schematic of one embodiment of the invention.

### BEST MODE

The purpose of the invention is to advance the art of LEDs used in agriculture so as to optimize the P.A.R. available to the plant. Specifically, the invention is adapted to provide photosynthetically active portions of the electromagnetic spectrum though the use of PPF-RGB-LEDs which can be mounted to a circuit hoard and programmed to emit time optimized P.A.R. in domain wavelength modulations.

Referring to FIG. 1, there is shown one embodiment of the invention being a PPF-RGB-LED having 9 emitters. Generally, two emitters will be blue at 470 nm, one emitters will be blue at 450 nm, two emitters will be red at 666 nm and one emitter will be red at 635 nm and one or three emitters will be green at 525 nm. Other variations of emitters can be set into a PPF-RGB-LED chassis to provide the required P.A.R. Typical voltage and amperages of these emitters are shown below.

350 mA 4.0 4.6V 30-401 m (640 nm, 668 nm)

350 mA 6.4-8.0V 90-1101 m (525 nm, 525 nm)

350 mA 6.4-8.0V 40-501 m (450 nm, 470 nm)

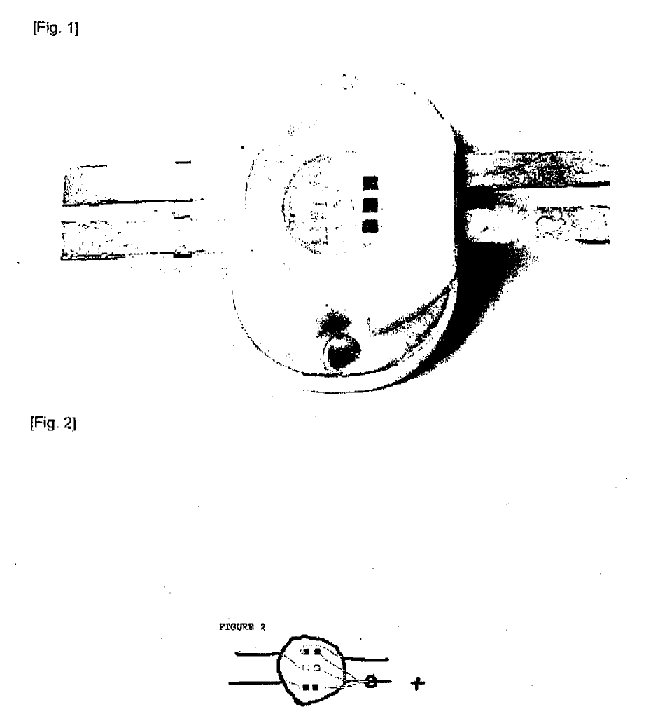

FIG. 2 and FIG. 3 illustrate PIN connections of embodiments of the PPF-RGB-LED.

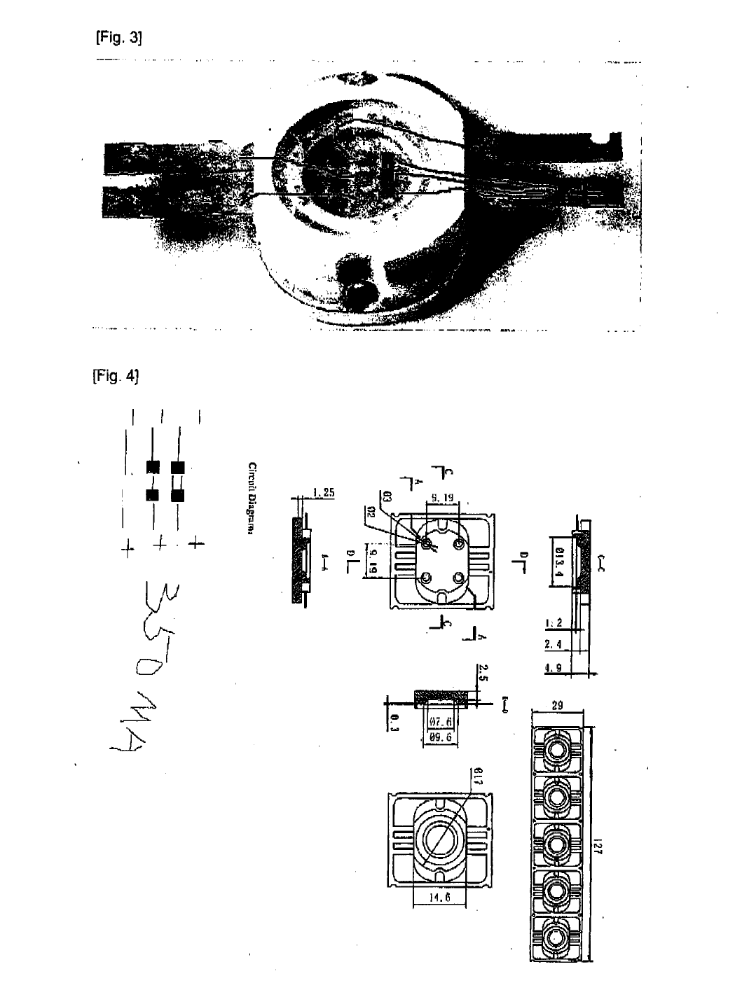

FIG. 4 shows a schematic of the construction of one embodiment of the invention and a circuit diagram.

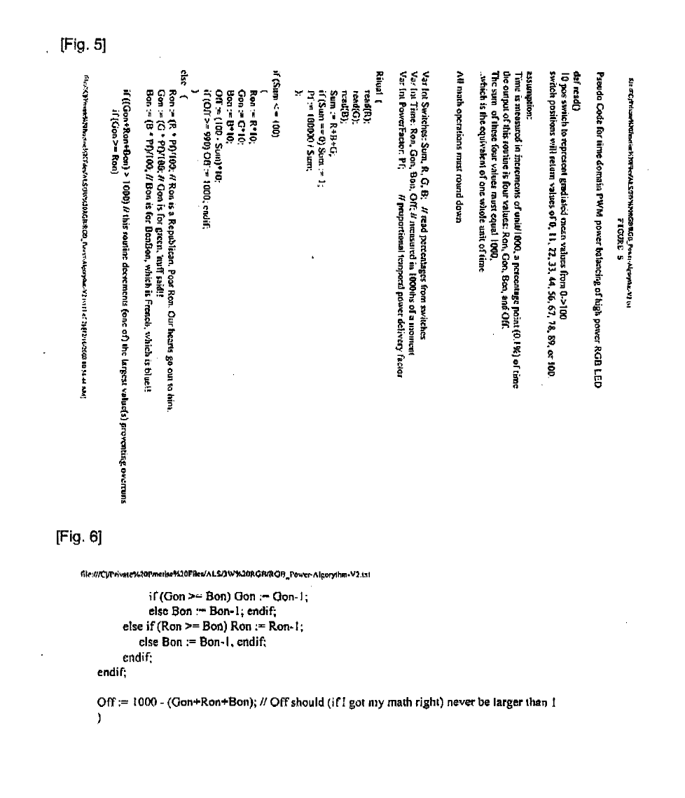

FIGS. 5 and 6 illustrate two respective embodiments of power algorithms that can be used to control emissions from a board of PPF-RGB-LEDs.

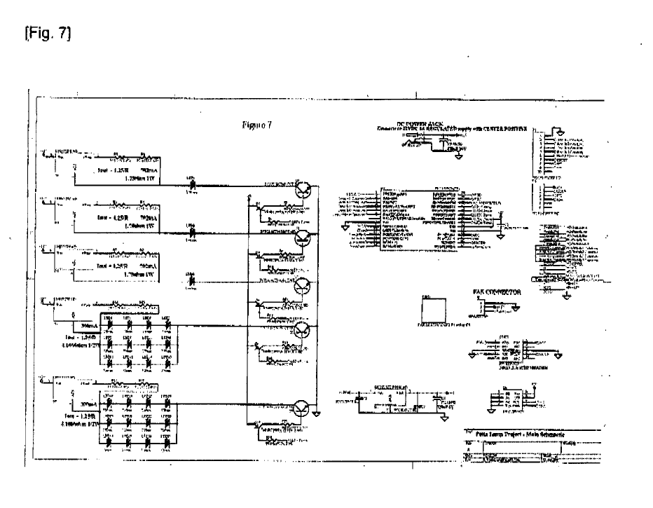

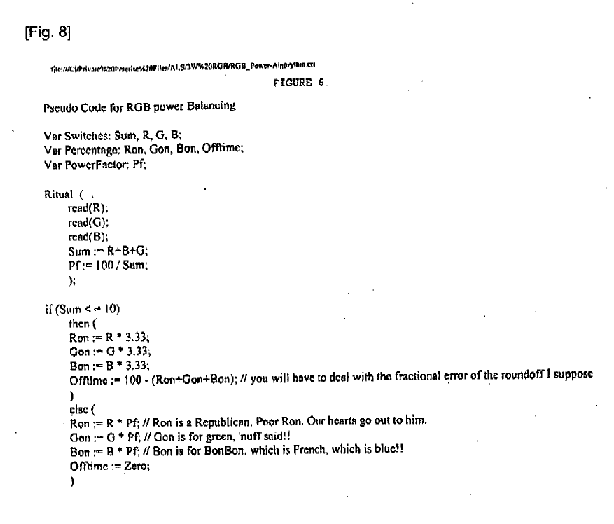

FIG. 7 illustrates a schematic circuit of one embodiment of the invention.

### Mode for Invention

### INDUSTRIAL APPLICABILITY

SEQUENCE LIST TEXT

What is claimed is:

1. A device for providing homogeneous radiometric exposure control of photosynthetic photon flux to a plant by the simultaneous emission of at least three wavelengths of photosynthetic active radiation having independently variable and controlled irradiance, wherein said at least three wavelengths originate from a single RGB LED package.

2. The device of claim 1, wherein said single RGB LED package comprises at least one LED emitting photosynthetic active radiation at wavelengths within the red, green and blue spectra.

3. The device of claim 2, wherein the single RGB LED package comprises at least three individual LEDs comprising one LED emitting within the blue spectra, one LED emitting within the green spectra and one LED emitting within the red spectra.

4. The device of claim 3, wherein said one LED emitting within the blue spectra emits photosynthetic active radiation at a wavelength of 450 nm; wherein said one LED emitting within the green spectra emits photosynthetic active radiation at 525 nm; and, wherein said one LED emitting within the red spectra emits photosynthetic active radiation at 640 nm.

5. The device of claim 3, wherein the one LED emitting within the blue spectra emits photosynthetic active radiation at a wavelength of 470 nm; and, wherein the one LED emitting within the red spectra emits photosynthetic active radiation at a wavelength of 666 nm.

6. The device of claim 2, wherein the single RGB LED package comprises at least rive LEDs emitting photosynthetic active radiation and comprising one LED emitting photosynthetic active radiation at 450 nm, one LED emitting photosynthetic active radiation at 470 nm, one LED emitting photosynthetic active radiation at 525 nm, one LED emitting photosynthetic active radiation at 640 nm and one LET) emitting photosynthetic active radiation at 666 nm.

7. The device of claim 2, wherein the single RGB LED package comprises at least nine LEDs emitting photosynthetic active radiation and comprising one LED emitting photosynthetic active radiation at 450 nm, two LEDs emitting photosynthetic active radiation at 470 nm, one LED emitting photosynthetic active radiation at 640 nm, two LEDs emitting photosynthetic active radiation at 668 nm and three LEDs emitting photosynthetic active radiation at emitters emitting light at 525 nm.

8. The device of claim 1, wherein said RGB LED package comprises an at least one LED emitter disposed within an area of one square centimetre so that color hotspots and color specific shadows are minimized.

9. The device of claim 1, wherein said RBG LED package comprises a plurality of LEDs for emitting photosynthetic active radiation for plant absorption, and wherein said plurality of emitters comprise materials sharing similar photomorphogenic effects on said plant.
